(19) United States
(12) Patent Application Publication
(10) Pub. No.: US 2025/0056566 A1
(43) Pub. Date: Feb. 13, 2025

(54) WIRELESS CONTROL SYSTEM, CONTROLLER, TERMINAL, AND STORAGE MEDIUM

(71) Applicant: KABUSHIKI KAISHA TOSHIBA, Tokyo (JP)

(72) Inventors: Tsuyoshi KOGAWA, Kawasaki Kanagawa (JP); Toshihisa NABETANI, Kawasaki Kanagawa (JP); Tomoya TANDAI, Ota Tokyo (JP)

(73) Assignee: KABUSHIKI KAISHA TOSHIBA, Tokyo (JP)

(21) Appl. No.: 18/590,709

(22) Filed: Feb. 28, 2024

(30) Foreign Application Priority Data
Aug. 10, 2023 (JP) 2023-131179

(51) Int. Cl. H04W 72/25; H04W 88/04

(52) U.S. Cl. CPC H04W 72/25; H04W 88/04

(57) ABSTRACT

According to one embodiment, a wireless control system includes terminals and a controller. The terminals can operate as a relayed or a downlink relay terminal. The downlink relay terminal is configured to transmit a first state signal representing a state of its own control target and a first control signal for controlling a control target of the relayed terminal. The relayed terminal is configured to obtain a second state signal representing a state of its own control target after receiving the first control signal, transmit the second state signal, and control its own control target based on the first control signal.

### CROSS-REFERENCE TO RELATED APPLICATIONS

This application is based upon and claims the benefit of priority from Japanese Patent Application No. 2023-131179, filed Aug. 10, 2023, the entire contents of which are incorporated herein by reference.

### FIELD

Embodiments described herein relate generally to a wireless control system, a controller, a terminal, and a storage medium.

### BACKGROUND

There are wireless control systems that include a controller and a plurality of terminals that are connected to the controller wirelessly. An example of the wireless control system is a control system for an industrial robot. The industrial robot includes a plurality of arms. A terminal is placed on the arms. The terminal includes a wireless device and a motor.

The controller transmits a control signal to the terminal. The terminal rotates the motor shaft and controls the arms according to the control signal. The terminal transmits a state signal to the controller. The state signal indicates the state of the arm (e.g., rotation angle of the arm), which is the result of the control. The controller updates the control signal according to the state signal and transmits the updated control signal to the terminal. That is, the controller performs feedback control.

In a feedback control system, it is desirable for the controller to generate a control signal according to the latest state signal as much as possible from the viewpoint of quality of control. If AoI (Age of Information) is considered as an elapsed time from an observation point of certain information, in the feedback control system, the quality of control can be made higher when the control signal is generated based on a state signal with short AoI than when the control signal is generated based on a state signal with long AoI. For example, in a case of updating a control signal at a fixed cycle for ease of control, it is preferable that the terminal transmits the latest state signal within one cycle after receiving the control signal. This makes it possible for the controller to generate a control signal according to the AoI state signal within one cycle, thereby increasing the quality of arm control to a certain level or higher. On the other hand, in a case where the terminal cannot transmit the latest state signal within one cycle after receiving the control signal and transmits it within the next cycle, the controller will generate the control signal according to the AoI state signal within a period more than one cycle and less than two cycles, and the quality of arm control will deteriorate. In addition, a direct wireless line between the controller and the terminal may be disconnected depending on the situation. For example, depending on the position of the arm, in some cases, obstacles may exist between the controller and the arm, and the terminal may not be able to receive the control signal from the controller, or the controller may not be able to receive the state signal from the terminal. In this case, the controller transmits signals to and receives signals from the terminal whose direct wireless line with the controller is disconnected via another terminal that is wirelessly connected to the controller. However, in the case of transmitting and receiving signals via the other terminal, in some cases, the controller may not be able to receive the state signal within one cycle after transmitting the control signal.

### BRIEF DESCRIPTION OF THE DRAWINGS

FIG. 1 illustrates an example of a wireless control system according to a first embodiment.

FIG. 2 is a block diagram illustrating an example of a controller according to the first embodiment.

FIG. 3 is a block diagram illustrating an example of a terminal according to the first embodiment.

FIGS. 4A, 4B, 4C, and 4D illustrate examples of a format of wireless frame according to the first embodiment.

FIG. 5A illustrates an example of processing of a DL relay terminal according to a reference example.

FIG. 5B illustrates an example of processing of a DL relay terminal according to the first embodiment.

FIG. 6A illustrates an example of processing of a relayed terminal according to the reference example.

FIG. 6B illustrates an example of processing of a relayed terminal according to the first embodiment.

FIG. 7A illustrates an example of processing of a UL relay terminal according to the reference example.

FIG. 7B illustrates an example of processing of a UL relay terminal according to the first embodiment.

FIG. 8A illustrates an example of a waveform of a wireless signal according to the reference example.

FIG. 8B illustrates an example of a signal at the DL relay terminal according to the reference example.

FIG. 8C illustrates an example of a signal at the relayed terminal according to the reference example.

FIG. 8D illustrates an example of a signal at the UL relay terminal according to the reference example.

FIG. 9A illustrates an example of a waveform of a wireless signal according to the first embodiment.

FIG. 9B illustrates an example of a signal at the DL relay terminal according to the first embodiment.

FIG. 9C illustrates an example of a signal at the relayed terminal according to the first embodiment.

FIG. 9D illustrates an example of a signal at the UL relay terminal according to the first embodiment.

FIG. 10 is a block diagram illustrating an example of a controller according to a second embodiment.

FIG. 11 illustrates an example of an operation of a state signal prediction unit according to the second embodiment.

FIG. 12 is a block diagram illustrating an example of a controller according to a third embodiment.

FIG. 13 is a block diagram illustrating an example of a controller according to a fourth embodiment.

FIG. 14 is a block diagram illustrating an example of a controller according to a fifth embodiment.

FIG. 15 is a block diagram illustrating an example of a terminal according to a sixth embodiment.

### DETAILED DESCRIPTION

Embodiments will be described below with reference to the drawings. In the following descriptions, a device and a method are illustrated to embody the technical concept of the embodiments. The technical concept is not limited to the configuration, shape, arrangement, material or the like of the structural elements described below. Modifications that could easily be conceived by a person with ordinary skill in the art are naturally included in the scope of the disclosure. To make the descriptions clearer, the drawings may schematically show the size, thickness, planer dimension, shape, and the like of each element differently from those in the actual aspect. The drawings may include elements that differ in dimension and ratio. Elements corresponding to each other are denoted by the same reference numeral and their overlapping descriptions may be omitted. Some elements may be denoted by different names, and these names are merely an example. It should not be denied that one element is denoted by different names. Note that “connection” means that one element is connected to another element via still another element as well as that one element is directly connected to another element. If the number of elements is not specified as plural, the elements may be singular or plural.

In general, according to one embodiment, a wireless control system includes terminals each including a control target, and a controller configured to receive a state signal transmitted from each of the terminals, generate a control signal for each of the terminals according to the state signal, and transmit the control signal. Each of the terminals can operate as a relayed terminal or a downlink relay terminal. The downlink relay terminal is configured to transmit a first state signal representing a state of its own control target and a first control signal for controlling a control target of the relayed terminal. The relayed terminal is configured to obtain a second state signal representing a state of its own control target after receiving the first control signal, transmit the second state signal, and control its own control target based on the first control signal.

### First Embodiment

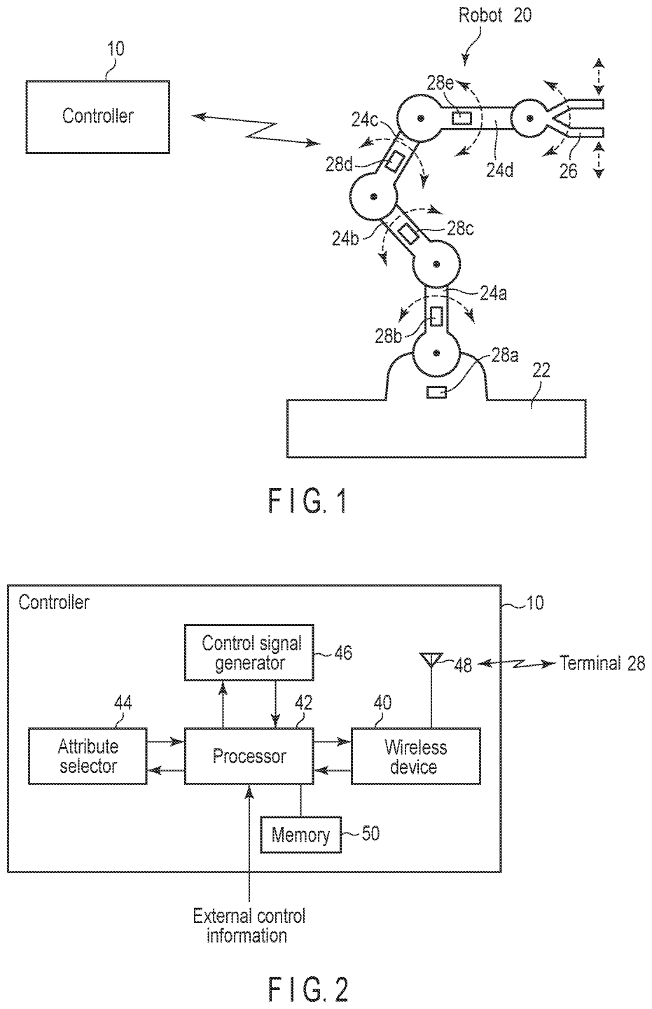

FIG. 1 illustrates an example of a wireless control system according to the first embodiment. The wireless control system includes a controller 10 and a robot 20. The robot 20 is an example of a control target. The control target is not limited to the robot 20.

The controller 10 includes a wireless device with functions that enable wireless communications with external devices, such as modulation and demodulation functions, and a processor for processing information transmitted and received via wireless communications.

An example of the robot 20 is an industrial robot that performs work such as picking packages flowing on a conveyor belt. The robot 20 includes a base 22, arms 24a, 24b, 24c, and 24d, and a gripper 26. The base 22 is installed on a floor, a desk, a stand, etc. The arm 24a is attached to the base 22. The angle/position of the arm 24a with respect to the base 22 is variable, as shown by a dashed line. Similarly, the arms 24b, 24c, and 24d are attached to the arms 24a, 24b, and 24c, respectively. The angle/position of the arms 24b, 24c, and 24d with respect to the arms 24a, 24b, and 24c is variable, as shown by dashed lines. The gripper 26, which can be opened and closed, is attached to the arm 24d at the distal end. The angle/position of the gripper 26 with respect to the arm 24d is variable. The total number of arms 24a to 24d is not limited to four, but can be any number. The plane of rotation of the arms 24 with respect to the base 22 may be parallel to the floor, the desk, the table, etc. If there is an arm in which the rotating surface of the arm relative to the base is parallel to the floor, desk, stand, etc., and an arm in which the rotating surface of the arm relative to the base is perpendicular to the floor, desk, table, etc., the position of the distal end arm 24d can be moved three-dimensionally.

The base 22 includes a terminal 28a. The arms 24a to 24d have terminals 28b, 28c, 28d, and 28e, respectively. The terminals 28a to 28e are wirelessly connected to the controller 10. The terminals 28a to 28d each have a motor that changes the angle/position of each of the arms 24a to 24d. The terminal 28e includes a motor that opens/closes the gripper 26.

As the shaft of the motor included in the terminal 28e rotates, the gripper 26 can open and close to pinch and grasp items or release items. As the shafts of the motors included in each of the terminals 28a to 28d rotate, the angle/position between the arm 24a and the base 22, the angle/position between the arm 24b and the arm 24a, the angle/position between the arm 24c and the arm 24b, the angle/position between the arm 24d and the arm 24c, or the rotation speed of each of the arms 24 can be controlled. By controlling the angle of the motor included in each of the terminals 28a to 28d, the gripper 26 can be moved to any position. By controlling the angle of the motor included in each of the terminals 28a to 28e, the work, such as transferring items flowing on the conveyor belt to a tray, can be performed.

The controller 10 transmits a control signal for each of the motors to the terminals 28a to 28e. The terminals 28a to 28e each transmit a motor state signal to the controller 10. The controller 10 receives the state signal of the motor, updates the control signal for the motor according to the state signal, and transmits the updated control signal to the motor of each of the terminals 28a to 28e. In a case where a wireless line between the controller 10 and a certain terminal 28 is disconnected, the controller 10 and the certain terminal 28 are connected to each other via another terminal. The control and state signals are relayed by the other terminal and transmitted and received between the controller 10 and the certain terminal 28. In the case where the controller 10 operates the other terminal as a relay terminal, it controls the order of multiple processes performed by the relay terminal to shorten the response time or improve the control quality of the wireless control system.

FIG. 2 is a block diagram illustrating an example of the controller 10 according to the first embodiment. The controller 10 includes a wireless device 40, a processor 42, an attribute selector 44, a control signal generator 46, an antenna 48, and a memory 50. The processor 42 is connected to the wireless device 40, the attribute selector 44, the control signal generator 46, and the memory 50 by a line.

The wireless device 40 receives a wireless frame transmitted from the terminal 28 by the antenna 48, demodulates the wireless frame, and generates a received signal. The wireless device 40 measures wireless characteristics of the wireless line between the terminal 28 and the controller 10. The wireless characteristics are information that represent the communication quality of the wireless line. An example of the wireless characteristics is the received power of the wireless frame. The wireless device 40 outputs measurement results of the wireless characteristics to the processor 42.

The wireless device 40 extracts a transmission source (ID of the terminal) and the state signal from the received signal. The wireless device 40 outputs the wireless characteristics, the transmission source, and the state signal to the processor 42. The processor 42 outputs a control signal and an attribute to the wireless device 40. The wireless device 40 modulates the control signal and the attribute and transmits them as the wireless frame from the antenna 48. Each terminal 28 can operate as a terminal with one of the attributes. The terminals 28 change the order of processing according to the attribute.

The processor 42 outputs the measurement results of the wireless characteristics output from the wireless device 40 or the results of calculations using the measurement results to the attribute selector 44. The attribute selector 44 selects the attribute of the terminal 28 based on the information output from the processor 42. The attribute selector 44 outputs the selected attribute to the processor 42.

For example, the attribute is a downlink (DL) relay terminal, a relayed terminal, an uplink (UL) relay terminal, or a general terminal. The DL relay terminal is a terminal that receives the control signal to the relayed terminal transmitted by the controller 10 and transmits the control signal to the relayed terminal, that is, a terminal that relays the control signal. The UL relay terminal is a terminal that receives the state signal to the controller 10 transmitted by the relayed terminal and transmits the state signal to the controller 10, that is, a terminal that relays the state signal. The relayed terminal is a terminal that has a disconnected wireless line with the controller 10, receives the control signal from the controller 10 via the DL relay terminal, and transmits the state signal to the controller 10 via the UL relay terminal. The general terminal is a terminal not involved in relaying, which receives the control signal directly from the controller 10 and transmits the state signal directly to the controller 10.

For example, a terminal with low communication quality is likely to have a disconnected wireless line with the controller 10, and can be determined to be the relayed terminal that requires a relay terminal. For example, a terminal with high communication quality can be determined to be usable as the relay terminal. When the position of the arm 24 of the robot 20 changes, the state of the wireless line changes. When the state of the wireless line changes, the attribute selector 44 changes the attribute to be selected.

The processor 42 stores information that is in the process of calculation in the memory 50. The processor 42 receives external control information. The processor 42 calculates a target value (e.g., a target value of rotation speed) based on the external control information. The processor 42 outputs the state signal output from the wireless device 40 and the target value to the control signal generator 46.

The attribute selector 44 outputs the attribute of each terminal 28 to the processor 42. The control signal generator 46 outputs the control signal for each terminal to the processor 42. The processor 42 outputs the attribute and the control signal of each terminal to the wireless device 40. An example of timing for outputting the attribute and the control signal of each terminal to the wireless device 40 is the timing of cycle T measured by a timer (not shown).

The external control information may be target value information of the rotation speed stored in an external memory (not shown). The external control information may be target value information of the rotation speed calculated from a pre-stored program (not shown). The external control information may be human commands via a computer (not shown), or may be information on pressing an emergency stop button (not shown).

The control signal generator 46 generates the control signal based on the target value and state signal output from the processor 42. The control signal generator 46 outputs the control signal to the processor 42.

The controller 10 can select the attribute of the terminal 28 based on the wireless frame transmitted from the terminal 28, generate the control signal for the terminal 28, and transmit the control signal to each of the terminals 28 in a fixed cycle.

The processor 42, the attribute selector 44, and the control signal generator 46 in FIG. 2 may be implemented by software or dedicated hardware. In the case of being implemented as software, the processor 42, the attribute selector 44, and the control signal generator 46 are implemented by a memory that stores a program and a CPU that executes the program. The processor 42, the attribute selector 44, and the control signal generator 46 may be implemented by CPUs that each execute a plurality of functions.

An example of a communication standard for transmitting and receiving control and state signals between the wireless device 40 and the terminal 28 is a wireless LAN (IEEE 802.11). The wireless device 40 may transmit and receive the control and state signals by other wireless communication standards such as ZigBee (registered trademark), local 5G, or other proprietary standards.

The control signal transmitted by the controller 10 may be a unicast signal addressed to one of the terminals 28 or a broadcast signal addressed to all the terminals 28.

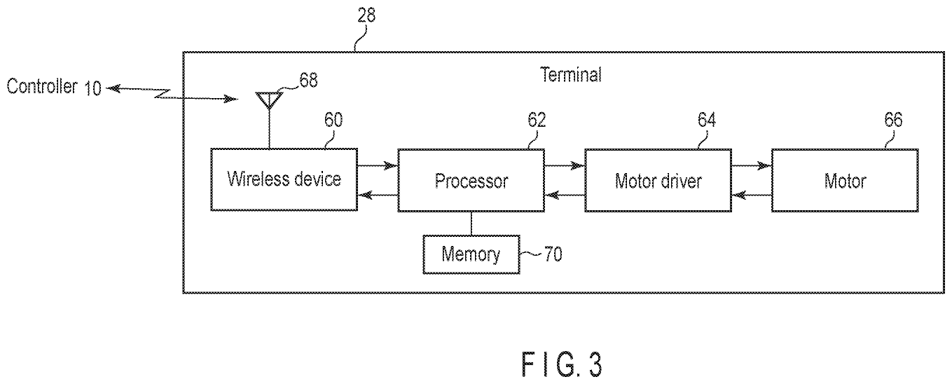

FIG. 3 is a block diagram illustrating an example of the terminal 28 according to the first embodiment. The terminal 28 includes a wireless device 60, a processor 62, a motor driver 64, a motor 66, an antenna 68, and a memory 70. The processor 62 is connected to the wireless device 60, the motor driver 64, and the memory 70 by wire. The motor driver 64 is connected to the motor 66 by wire.

The wireless device 60 receives the wireless frame transmitted from the controller 10 or other terminals 28 with the antenna 68 and demodulates the wireless frame to generate a received signal. The wireless device 60 extracts a transmission source, a control signal, and an attribute from the received signal. The wireless device 60 outputs the extracted transmission source, control signal, and attribute to the processor 62. The wireless device 60 receives a destination (terminal ID), an attribute, and a state signal output from the processor 62, modulates the input information, and transmits the modulated information as a wireless frame from the antenna 68.

The processor 62 writes the information output from the wireless device 60 into the memory 70. The processor 62 determines the attribute and destination in the information output from the wireless device 60 and processes the information accordingly.

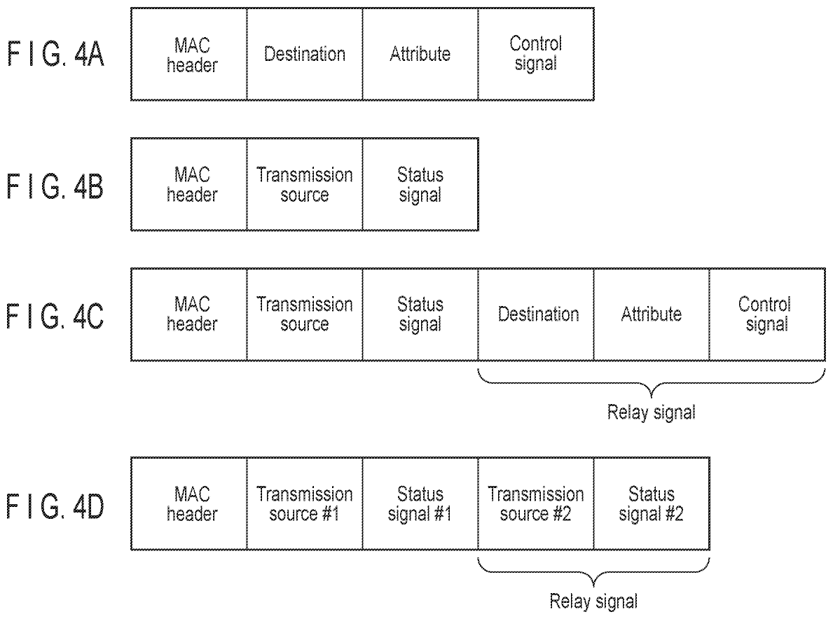

In a case where the attribute is the DL relay terminal and the destination is its own terminal, the processor 62 outputs a state signal request signal to the motor driver 64 requesting a state signal. The processor 62 receives the state signal output from the motor driver 64 and outputs the state signal (including the transmission source) and the control signal (including the destination and attribute) of the relayed terminal (FIG. 4C) to the wireless device 60. The processor 62 outputs the control signal (control signal included in FIG. 4A) to the motor driver 64. The order of outputting the state and control signals to the wireless device 60 and outputting the control signal to the motor driver 64 may be reversed to that described above.

In a case where the attribute is the DL relay terminal and the destination is the relayed terminal, the processor 62 writes the control signal (including the destination and attribute) of the relayed terminal to the memory 70. In a case where the attribute is the DL relay terminal and the destination is other than the relayed terminal, the processor 62 discards information (such as the control signal) relating to the destination.

In a case where the attribute is the relayed terminal and the destination is its own terminal, the processor 62 outputs the state signal request signal to the motor driver 64, receives the state signal output from the motor driver 64, outputs the state signal (including the transmission source) to the wireless device 60 (FIG. 4B), and outputs the control signal to the motor driver 64. The order of outputting the state signal to the wireless device 60 and outputting the control signal to the motor driver 64 may be reversed to that described above.

In a case where the attribute is the relayed terminal and the destination is other than its own terminal, the processor 62 discards information (such as the control signal) relating to the destination.

In a case where the attribute is the UL relay terminal and the destination is its own terminal, the processor 62 outputs the control signal to the motor driver 64 and outputs the state information request signal to the motor driver 64. The processor 62 receives the state signal output from the motor driver 64 and outputs the state signal (including the transmission source) and the state signal of the relayed terminal (including the transmission source) to the wireless device 60 (FIG. 4D). The processor 62 does not output the two state signals to the wireless device 60 until the control signal of the relayed terminal arrives.

In a case where the attribute is the UL relay terminal and the transmission source is the relayed terminal, the processor 62 writes the state signal of the relayed terminal (including the transmission source) to the memory 70. In a case where the attribute is the UL relay terminal and the destination is other than the relayed terminal, the processor 62 discards information (such as the state signal) relating to the destination.

In a case where the attribute is the general terminal and the destination is its own terminal, the processor 62 outputs the control signal to the motor driver 64 and outputs the state information request signal to the motor driver 64. The processor 62 outputs the state signal output from the motor driver 64 to the wireless device 60 (FIG. 4B). In a case where the attribute is the general terminal and the destination is other than its own terminal, the processor 62 discards information (such as the state signal) relating to the destination.

The motor driver 64 receives the control signal or the state signal request signal from the processor 62. In a case where the motor driver 64 receives the control signal, it controls the motor 66 according to the control signal. In a case where the motor driver 64 receives the state signal request signal, the motor driver 64 receives an encoder value representing the rotation speed from an encoder (not shown) associated with the motor 66 as the state signal. The motor driver 64 outputs the receive state signal to the processor 62.

The shaft of the motor 66 rotates according to the control signal output from the motor driver 64. The encoder associated with the motor 66 outputs an encoder value (also referred to as a sensor value, a hall sensor value, or a setting parameter value) representing the rotation speed of the motor 66 to the motor driver 64.

The motor 66 converts electric power into rotational motion, etc. The encoder value of the motor 66, such as the rotation speed, determines the position of the arm 24. The motor 66 may also serve as a sensor for sensing the position of the arm 24, the gripper 26, or the terminal 28. The encoder value of the motor 66 corresponds to the sensor value. The center of rotation of the motor 66 may sometimes be referred to as the axis.

The terminal 28 writes into the memory 70 the attribute of its own terminal included in the wireless frame received immediately before. The terminal 28 operates as the terminal of the attribute stored in the memory 70 and executes multiple processes in the order according to the attribute. In a case where the attribute included in the received wireless frame is different from the stored attribute, the attribute stored in the memory 70 is updated.

The processor 62 in FIG. 3 may be implemented by software or dedicated hardware. In the case of being implemented as software, the processor 62 is implemented by a memory that stores a program and a CPU that executes the program. The processor 62 may be implemented by multiple CPUs that each execute a plurality of functions.

Although an example where each terminal 28 includes one motor 66 is shown, each terminal 28 may include multiple motors instead of one motor 66. In that case, the controller 10 may include a motor ID in the destination of the control signal. The terminal 28 may select and control one of the multiple motors based on the motor ID specified in the destination of the control signal.

Although an example where the terminal 28 includes one wireless device 60 is shown, the terminal 28 may include multiple wireless devices 60.

Although FIG. 1 shows a wireless control system including one robot 20, the embodiment is not limited to one robot 20 and may include a plurality of robots. The controller 10 need not be limited to controlling one robot 20 and may control a plurality of robots 20. The wireless control system may include a plurality of controllers 10.

FIG. 4A to FIG. 4D illustrate examples of a format of the wireless frame according to the first embodiment.

FIG. 4A shows an example of the wireless frame transmitted by the controller 10. The wireless frame includes a MAC header, a destination, an attribute, and a control signal. The MAC header includes a MAC address of the destination terminal 28, a MAC address of the transmission source (controller 10), etc. The destination represents an ID of the terminal 28 to which the wireless frame is transmitted. The attribute represents the attribute of the destination terminal 28. The control signal represents a control target value of the destination terminal 28. An example of the control target value is a target angular velocity of the motor 66.

Note that FIG. 4A is an example of a case where the controller 10 performs transmission to each terminal by unicast. In a case where the controller 10 performs transmission to each terminal by broadcast, the attribute and the control signal addressed to each terminal are included in one wireless frame (not shown).

FIG. 4B shows an example of the wireless frame transmitted by the terminal 28 whose attribute is the relayed terminal or the general terminal. The wireless frame includes a MAC header, a transmission source, and a state signal. The MAC header is the same as the MAC header in FIG. 4A. The transmission source represents an ID of its own terminal 28. The state signal represents a state signal (encoder value, sensor value, etc.) of its own terminal 28.

FIG. 4C shows an example of the wireless frame transmitted by the terminal 28 whose attribute is the DL relay terminal. The wireless frame includes a MAC header, a transmission source, a state signal, a destination, an attribute, and a control signal. The MAC header is the same as the MAC header in FIG. 4A. The transmission source and the state signal represent an ID and a state signal (encoder value, sensor value, etc.) of its own terminal 28, respectively. The destination, the attribute, and the control signal represent an ID, an attribute, and a control signal of the terminal 28 whose attribute is the relayed terminal, respectively. Each of the destination, the attribute, and the control signal is the same as the destination, the attribute, and the control signal included in the wireless frame shown in FIG. 4A. The destination, the attribute, and the control signal form a relay signal transmitted to the relayed terminal.

FIG. 4D shows an example of the wireless frame transmitted by the terminal 28 whose attribute is the UL relay terminal. The wireless frame includes a MAC header, a transmission source #1, a state signal #1, a transmission source #2, and a state signal #2. The MAC header is the same as the MAC header in FIG. 4A. The transmission source #1 represents an ID of its own terminal 28. The state signal #1 represents a state signal (encoder value, sensor value, etc.) of its own terminal 28. The transmission source #2 is the same as the transmission source included in the wireless frame transmitted by the relayed terminal or general terminal shown in FIG. 4B. The state signal #2 is the same as the state signal included in the wireless frame transmitted by the relayed terminal or general terminal shown in FIG. 4B. The transmission source #2 and the state signal #2 form a relay signal transmitted to the controller 10.

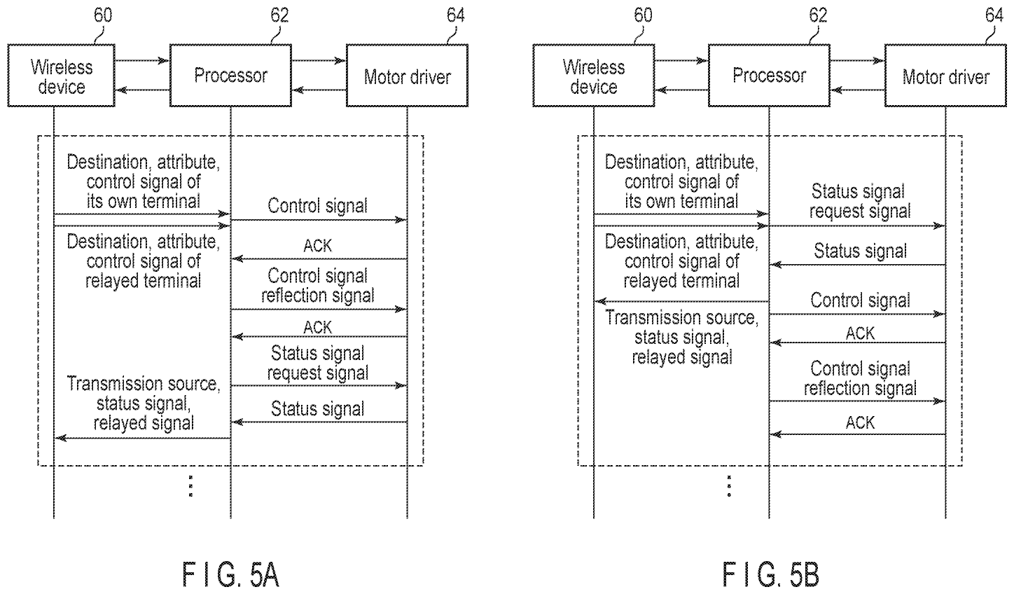

FIG. 5A and FIG. 5B illustrate an example of processing of the terminal 28 operating as the DL relay terminal according to the first embodiment. FIG. 5A shows an example of the processing of the DL relay terminal according to a reference example. FIG. 5B shows an example of the processing of the DL relay terminal according to the first embodiment.

In the DL relay terminal according to the reference example (FIG. 5A), when the wireless device 60 receives the wireless frame (FIG. 4A) transmitted from the controller 10, the wireless device 60 outputs destinations, attributes, and control signals of its own terminal and of the relayed terminal to the processor 62. The processor 62 outputs the control signal of its own terminal to the motor driver 64. The processor 62 writes the control signal together with the destination and the attribute of the relayed terminal into the memory 70 as a relay signal.

When the motor driver 64 receives the control signal, the motor driver 64 outputs an ACK, which is a response confirmation, to the processor 62. When the processor 62 receives the ACK, the processor 62 outputs a control signal reflection signal to the motor driver 64. In a case where the processor 62 does not receive the ACK within a certain period of time, the processor 62 outputs the control signal of its own terminal to the motor driver 64 again.

When the motor driver 64 receives a control signal reflection signal, the motor driver 64 drives the motor 66 at a target rotation speed indicated by the control signal and outputs an ACK, which is a response confirmation, to the processor 62. When the processor 62 receives the ACK, the processor 62 outputs a state signal request signal to the motor driver 64. In a case where the processor 62 does not receive the ACK within a certain period of time, the processor 62 outputs the control signal reflection signal to the motor driver 64 again. When the motor driver 64 receives a state signal request signal, the motor driver 64 outputs a state signal to the processor 62.

When the processor 62 receives the state signal, the processor 62 reads the relay signal (the destination, the attribute, and the control signal of the relayed terminal) from the memory 70. The processor 62 outputs the transmission source (ID of its own terminal), the state signal, and the relay signal to the wireless device 60. The wireless device 60 transmits the wireless frame shown in FIG. 4C.

The processor 62 executes the above series of processing repeatedly.

In the terminal 28 operating as the DL relay terminal according to the first embodiment (FIG. 5B), when the wireless device 60 receives the wireless frame (FIG. 4A) transmitted from the controller 10, the wireless device 60 outputs destinations, attributes, and control signals of its own terminal and a relayed terminal to the processor 62. The processor 62 writes the control signal of its own terminal together with the destination and the attribute into the memory 70, and also writes the control signal of the relayed terminal together with the destination and the attribute into the memory 70. The control signal, the destination, and the attribute form the relay signal.

The processor 62 outputs the state signal request signal to the motor driver 64. When the motor driver 64 receives the state signal request signal, the motor driver 64 outputs the state signal to the processor 62.

When the processor 62 receives the state signal, the processor 62 reads the destination, the attribute, and the control signal of the relayed terminal from the memory 70. The destination, the attribute, and the control signal of the relayed terminal are referred to here as the relay signal. The processor 62 outputs the transmission source (ID of its own terminal), the state signal, and the relay signal to wireless device 60. The wireless device 60 transmits the wireless frame shown in FIG. 4C.

The processor 62 outputs the control signal of its own terminal to the motor driver 64. When the motor driver 64 receives the control signal, the motor driver 64 outputs the ACK, which is a response confirmation, to the processor 62. When the processor 62 receives the ACK, the processor 62 outputs the control signal reflection signal to the motor driver 64. In a case where the processor 62 does not receive the ACK within a certain period of time, the processor 62 outputs the control signal of its own terminal to the motor driver 64 again.

When the motor driver 64 receives the control signal reflection signal, the motor driver 64 drives the motor 66 at the target rotation speed indicated by the control signal. The motor driver 64 outputs the ACK, which is a response confirmation, to the processor 62. In a case where the processor 62 does not receive the ACK within a certain period of time, the processor 62 outputs the control signal reflection signal to the motor driver 64 again.

The processor 62 executes the above series of processing repeatedly.

The wireless frame (FIG. 4C) transmitted by the terminal 28 operating as the DL relay terminal according to the first embodiment includes the relay signal. The relay signal includes the control signal of the relayed terminal. When comparing the processing in FIG. 5A and FIG. 5B, in the processing in FIG. 5B, the relay signal including the control signal of the relayed terminal is transmitted from the DL relay terminal earlier than in the processing in FIG. 5A. Therefore, in the first embodiment, since the terminal 28 that operates as the relayed terminal receives the control signal earlier than the relayed terminal of the reference example, the control of the terminal 28 that operates as the relayed terminal is accelerated.

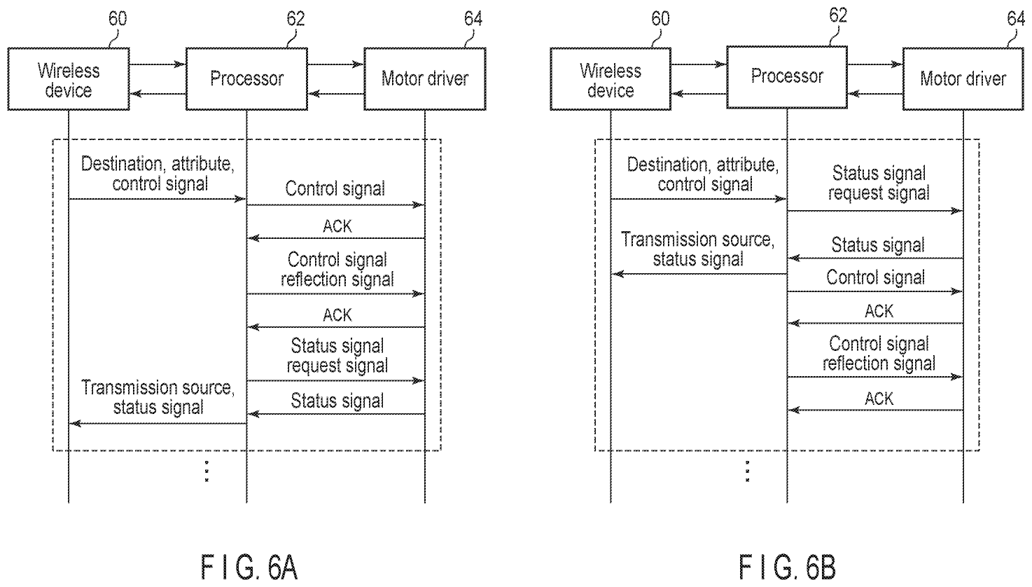

FIG. 6A and FIG. 6B illustrate an example of processing of the terminal 28 operating as the relayed terminal according to the first embodiment. FIG. 6A shows an example of the processing of the relayed terminal according to a reference example. FIG. 6B shows an example of the processing of the relayed terminal according to the first embodiment.

In the relayed terminal according to the reference example (FIG. 6A), when the wireless device 60 receives the wireless frame (FIG. 4A) transmitted from the controller 10 or the wireless frame (FIG. 4C) transmitted from another DL relay terminal, the wireless device 60 outputs the destination, the attribute, and the control signal to the processor 62. The processor 62 outputs the control signal of its own terminal to motor driver 64. The processor 62 discards information (the control signal, etc.) relating to other terminals.

When the motor driver 64 receives the control signal, the motor driver 64 outputs the ACK, which is a response confirmation, to the processor 62. When the processor 62 receives the ACK, the processor 62 outputs the control signal reflection signal to the motor driver 64. In a case where the ACK cannot be received within a certain period of time, the processor 62 outputs the control signal to the motor driver 64 again.

When the motor driver 64 receives the control signal reflection signal, the motor driver 64 drives the motor 66 at the target rotation speed indicated by the control signal. The motor driver 64 outputs the ACK, which is a response confirmation, to the processor 62. When the processor 62 receives the ACK, the processor 62 outputs a state signal request signal to the motor driver 64. In a case where the processor 62 does not receive the ACK within a certain period of time, the processor 62 outputs the control signal reflection signal to the motor driver 64 again. When the motor driver 64 receives the state signal request signal, the motor driver 64 outputs the state signal to the processor 62.

When the processor 62 receives the state signal, the processor 62 outputs the transmission source (its own terminal) and the state signal to the wireless device 60. The wireless device 60 transmits the wireless frame shown in FIG. 4B.

The processor 62 executes the above series of processing repeatedly.

In the terminal 28 operating as the relayed terminal (FIG. 6B) according to the first embodiment, when the wireless device 60 receives the wireless frame (FIG. 4A) transmitted from the controller 10 or the wireless frame (FIG. 4C) transmitted from another DL relay terminal, the wireless device 60 outputs the destination, the attribute, and the control signal to the processor 62. The processor 62 writes the control signal of its own terminal into the memory 70.

The processor 62 outputs the state signal request signal to the motor driver 64. When the motor driver 64 receives the state signal request signal, the motor driver 64 outputs the state signal to the processor 62.

When the processor 62 receives the state signal, the processor 62 outputs the transmission source (its own terminal) and the state signal to the wireless device 60. The wireless device 60 transmits the wireless frame shown in FIG. 4B.

The processor 62 reads the control signal from the memory 70. The processor 62 outputs the control signal to the motor driver 64. When the motor driver 64 receives the control signal, the motor driver 64 outputs the ACK, which is a response confirmation, to the processor 62. When the processor 62 receives the ACK, the processor 62 outputs the control signal reflection signal to the motor driver 64. In a case where the processor 62 does not receive the ACK within a certain period of time, the processor 62 outputs the control signal to the motor driver 64 again.

When the motor driver 64 receives the control signal reflection signal, the motor driver 64 drives the motor 66 at the target rotation speed indicated by the control signal and outputs the ACK, which is a response confirmation, to the processor 62. In a case where the processor 62 does not receive the ACK within a certain period of time, the processor 62 outputs the control signal reflection signal to the motor driver 64 again.

The processor 62 executes the above series of processing repeatedly.

When comparing the processing in FIG. 6A and FIG. 6B, in the processing in FIG. 6B, the state signal is transmitted from the relayed terminal earlier than in the processing in FIG. 6A. Therefore, in the first embodiment, since the controller 10 receives the state signal earlier than in the reference case, the response of the control system is accelerated.

Note that, in a case where the relayed terminal 28 according to the first embodiment receives the wireless frame (FIG. 4A) transmitted directly from the controller 10 and the wireless frame (FIG. 4C) relayed from the DL relay terminal in duplicate, processing in FIG. 6B may be performed with respect to the wireless frame received first, and the above processing may be skipped for the wireless frame received thereafter. Determination on whether or not two or more received frames overlap may be made based on the content of the control signal. In a case where a sequence number is assigned to the wireless frame, determination may be based on the sequence number.

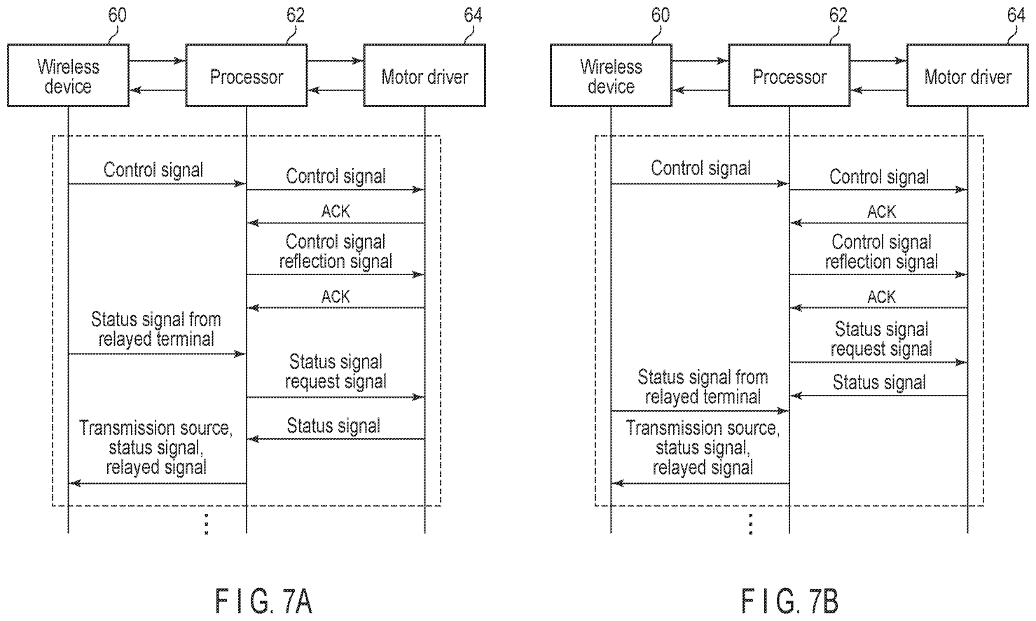

FIG. 7A and FIG. 7B illustrate an example of processing of the terminal 28 operating as the UL relay terminal according to the first embodiment. FIG. 7A shows an example of the processing of the UL relay terminal according to a reference example. FIG. 7B shows an example of the processing of the UL relay terminal according to the first embodiment.

In the UL relay terminal according to the reference example (FIG. 7A), when the wireless device 60 receives the wireless frame (FIG. 4A) transmitted from the controller 10, the processor 62 outputs the control signal of its own terminal to the motor driver 64. When the processor 62 receives the wireless frame (FIG. 4B) transmitted from the relayed terminal, the processor 62 writes the state signal of the relayed terminal together with the transmission source into the memory 70 as a relay signal.

When the motor driver 64 receives the control signal, the motor driver 64 outputs the ACK, which is a response confirmation, to the processor 62. When the processor 62 receives the ACK, the processor 62 outputs the control signal reflection signal to the motor driver 64. In a case where the processor 62 does not receive the ACK within a certain period of time, the processor 62 outputs the control signal of its own terminal to the motor driver 64 again.

When the motor driver 64 receives the control signal reflection signal, the motor driver 64 drives the motor 66 at the target rotation speed indicated by the control signal and outputs the ACK, which is a response confirmation, to the processor 62. When the processor 62 receives the ACK, the processor 62 outputs the state signal request signal to the motor driver 64. In a case where the processor 62 does not receive the ACK within a certain period of time, the processor 62 outputs the control signal reflection signal to the motor driver 64 again. When the motor driver 64 receives the state signal request signal, the motor driver 64 outputs the state signal to the processor 62.

When the processor 62 receives the state signal, the processor 62 reads the relay signal (transmission source and state signal) from the memory 70 and outputs the transmission source (its own terminal), the state signal, and the relay signal to the wireless device 60. The wireless device 60 transmits the wireless frame shown in FIG. 4D. In a case where the relay signal (transmission source and state signal) has not been written to the memory 70 at the time when the processor 62 receives the state signal, the processor 62 outputs only the state signal from the motor driver 64 or the state signal from the motor driver 64 and the state signal for the previous control signal addressed to the relayed terminal as the relay signal to the wireless device 60.

The processor 62 executes the above series of processing repeatedly.

The UL relay terminal according to the first embodiment (FIG. 7B) operates almost the same as the UL relay terminal according to the reference example (FIG. 7A). The first embodiment differs from the reference example in that, in a case where the relay signal (transmission source, state signal) has not been written to the memory 70 at the time when the processor 62 has received the state signal, or in a case where the memory 70 has not been not updated since no state signal has been received from the relayed terminal, the processor 62 does not output any signal to the wireless device 60 and continues to wait until the processor 62 receives a state signal from the relayed terminal.

When comparing the processing in FIG. 7A and FIG. 7B, in the processing in FIG. 7A, depending on the reception timing of the state signal transmitted by the relayed terminal, the signal is not relayed or an old state signal is relayed. However, in the processing shown in FIG. 7B, the latest state signal transmitted by the relayed terminal is always relayed.

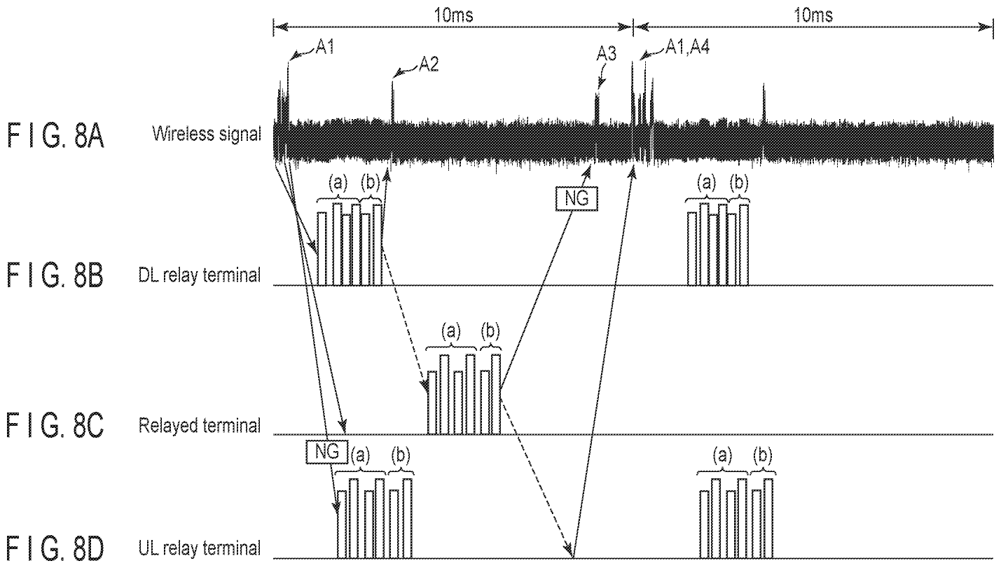

FIG. 8A to FIG. 8D illustrate an example of experimental results in the wireless control system according to the reference example. It is assumed that the number of terminals 28 is three. In the reference example, the DL relay terminal executes the processing shown in FIG. 5A, the relayed terminal executes the processing shown in FIG. 6A, and the UL relay terminal executes the processing shown in FIG. 7A. The controller 10 controls the motor 66 of each of the three terminals 28 at a control cycle of 10 ms. FIG. 8A to FIG. 8D show waveforms of a wireless signal and internal signals of the three terminals monitored by a digital oscilloscope and partially customized when the three motors are being controlled.

FIG. 8A shows the waveform of the wireless signal transmitted and received by the controller 10. The wireless signal includes a cluster of a plurality of peaks A1 with a 10 ms cycle. The cluster of a plurality of peaks A1 represents the control signals transmitted by the controller 10 to the three terminals. The wireless signal includes peak A2 approximately 4 ms after the cluster of a plurality of peaks A1. The peak A2 represents the state signal transmitted by the DL relay terminal. The wireless signal includes peak A3 approximately 9 ms after the cluster of a plurality of peaks A1. The peak A3 represents the state signal transmitted by the relayed terminal. The wireless signal includes peak A4 approximately 10.2 ms after the cluster of a plurality of peaks A1. The peak A4 overlaps with the cluster of a plurality of peaks A1. The peak A4 represents the state signal transmitted by the UL relay terminal.

FIG. 8B shows signal waveforms between the processor 62 and the motor driver 64 at the DL relay terminal. Approximately 1 ms after the controller 10 transmits the control signal, six high-level signal clusters are communicated. One cluster of the high-level signal represents one frame exchanged in the communication between the processor 62 and the motor driver 64. The six frames are, in order: the control signal, the ACK for the control signal, the control signal reflection signal, the frame group A of ACK for the control signal reflection signal, the state signal request signal, and the frame group (b) of state signal. Approximately 0.5 ms after the state signal request signal and the frame group (b) of state signal, the DL relay terminal transmits the state signal (A2 in FIG. 8A).

FIG. 8C shows signals between the processor 62 and the motor driver 64 at the relayed terminal. Approximately 1 ms after the DL relay terminal transmits the state signal, a cluster of six frames is communicated. The six frames are the same as those at the DL relay terminal. Approximately 3 ms after the frame of the state signal, the relayed terminal transmits the state signal.

FIG. 8D shows signals between the processor 62 and the motor driver 64 at the UL relay terminal. Approximately 1 ms after the controller 10 transmits the control signal, six high-level signal clusters are communicated. The six frames are the same as those in the DL relay terminal. Approximately 1.2 ms after the wireless frame of the state signal of the relayed terminal is transmitted, the UL relay terminal transmits the state signal.

The controller 10 can receive the state signal of the DL relay terminal before the timing of the transmission of the next control signal after the transmission of the control signal. Therefore, the controller 10 can generate and transmit the control signal with reflecting the state signal. The quality of control can be maintained at a high level. In some cases, the controller 10 may not be able to receive the state information of the relayed terminal and the UL relay terminal by the timing of the next control signal transmission. The controller 10 is unable to perform the desired control.

Note that, in the case where the UL relay terminal executes the processing shown in FIG. 7A, the controller 10 can receive the state signal of the UL relay terminal by the next control signal transmission timing. However, since the state signal of the relayed terminal is not relayed, the controller 10 cannot receive the state signal of the relayed terminal before the next control signal transmission timing. In this case, the controller 10 is unable to perform the desired control.

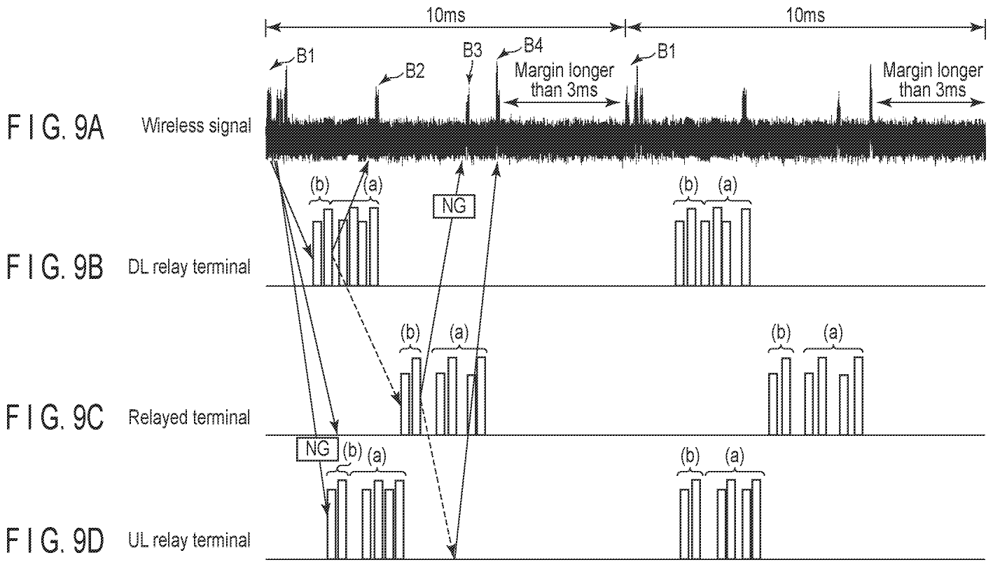

FIG. 9A to FIG. 9D illustrate an example of experimental results in the wireless control system according to the first embodiment. It is assumed that the number of terminals 28 is three. The DL relay terminal executes the processing shown in FIG. 5B, the relayed terminal executes the processing shown in FIG. 6B, and the UL relay terminal executes the processing shown in FIG. 7B. Explanations of the same operations as in FIG. 8A to FIG. 8D are omitted.

The DL relay terminal gives priority in timing to receiving the state signal from the motor 66 and transmitting the state signal as a wireless frame rather than reflecting the control signal to driving the motor 66. As a result, the DL relay terminal transmits the state signal request signal and the frame group (b) of state signal earlier than the control signal, the ACK for the control signal, the control signal reflection signal, and the frame group (a) of ACK for the control signal reflection signal.

The relayed terminal, in the same manner as the DL relay terminal, gives priority in timing to inputting the state signal from the motor 66 and transmitting the state signal as a wireless frame rather than reflecting the control signal to drive the motor 66. As a result, the relayed terminal transmits the state signal request signal and the frame group (b) of state signal earlier than the control signal, the ACK for the control signal, the control signal reflection signal, and the frame group (a) of ACK for the control signal reflection signal.

The UL relay terminal executes the same processing as in FIG. 8A to FIG. 8D; however, receives the state signal transmitted by the relayed terminal at an earlier timing than in the case of FIG. 8A to FIG. 8D. Therefore, the UL relay terminal also transmits the state signal of the UL relay terminal at an earlier timing than in the case of FIG. 8A to FIG. 8D.

The controller 10 according to the first embodiment receives the state signal of the DL relay terminal, the state signal of the relayed terminal, and the state signal of the UL relay terminal between a certain transmission timing of the control signal and the next transmission timing of the control signal. The controller 10 generates and transmits control signals with reflecting those state signals. This shortens a response time in the wireless control system including the controller 10 and the terminals 28 that are feedback-controlled by the controller 10, and suppresses deterioration in the quality of control of the motors 66 of the terminals 28.

Although the relayed terminal is described as a terminal whose wireless line with the controller 10 is disconnected, the wireless line does not necessarily have to be disconnected. Among the plurality of terminals, the terminal with a low-quality wireless line with the controller may be used as the relayed terminal. Alternatively, the quality of the wireless line between the controller and each terminal are predicted based on the state signal or the control signal of each terminal, and the terminal with the predicted low-quality wireless line may be used as the relayed terminal.

Although it has been explained that each terminal extracts the attribute from the received signal and performs processing accordingly, each terminal may extract the attribute and the destination from the received signal and perform processing accordingly, or may perform processing as the relayed terminal. For example, in a case where the attribute is the DL relay terminal, and the destination is a terminal other than its own terminal, the processor 62 does not discard information (control information, etc.) related to the destination. If a relay signal addressed to its own terminal is included in the received signal, the terminal performs processing as the relayed terminal. On the other hand, if a relay signal addressed to its own terminal is not included in the received signal, the attribute is not updated, and the processor 62 discards the information (control information, etc.) related to the destination. In this manner, even in a case where the wireless line of a certain terminal is suddenly disconnected, and the attribute change by the controller is not made in time, the terminal can be controlled as the relayed terminal.

### Second Embodiment

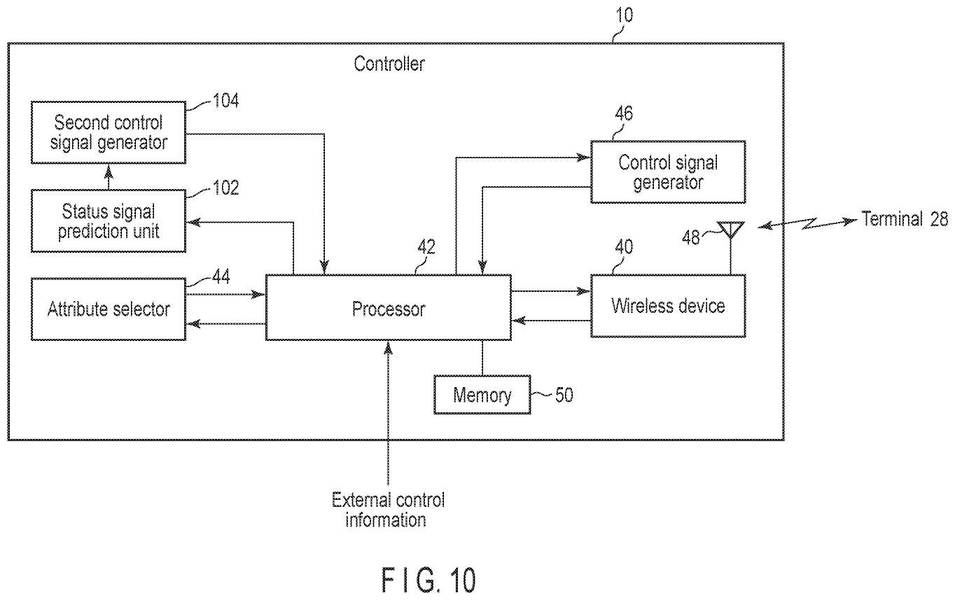

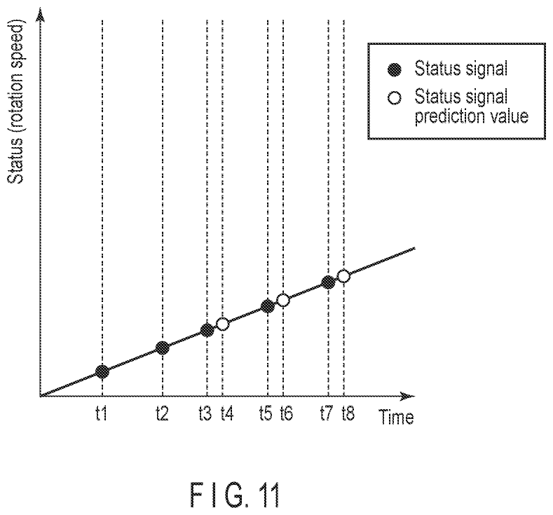

FIG. 10 is a block diagram illustrating an example of the controller 10 according to the second embodiment. Parts corresponding to those of the first embodiment are given the same reference numerals, and detailed explanations are omitted.

The controller 10 includes the wireless device 40, the processor 42, the attribute selector 44, the control signal generator 46, and the antenna 48, the memory 50. The controller 10 further includes a state signal prediction unit 102, and a second control signal generator 104. The memory 50 stores one past state signal for each terminal 28. The processor 42 outputs a target value, a current state signal, and the one past state signal of a DL relay terminal to the state signal prediction unit 102, and outputs target values and state signals of terminals other than the DL relay terminal to the control signal generator 46. The processor 42 receives a control signal of the DL relay terminal from the second control signal generator 104 and outputs the control signal to the wireless device 40. The processor 42 receives control signals of terminals other than the DL relay terminal from the control signal generator 46 and outputs the control signals to the wireless device 40.

The function of the terminal 28 changes according to an attribute selected by the attribute selector 44 of the controller 10. The attribute of a certain terminal 28 may be the general terminal until a certain timing and may change to the DL relay terminal after the certain timing. As shown in FIG. 5B, in the DL relay terminal, the timing at which the wireless device 60 transmits the state signal is earlier than the timing at which the processor 62 outputs the control signal to the motor driver 64. The state signal transmitted by the DL relay terminal is old information that does not accurately reflect the state after control by the current control signal.

To improve this point, the controller 10 according to the second embodiment includes the state signal prediction unit 102 and the second control signal generator 104. Note that the general terminal transmits the state signal after outputting the control signal to the motor driver 64. When the processor 42 receives the current state signal of the DL relay terminal, the processor 42 reads one past state signal of the DL relay terminal from the memory 50, and outputs the target value, the current state signal, and one past state signal of the DL relay terminal to the state signal prediction unit 102. The state signal prediction unit 102 generates a state signal prediction value based on the state signal and outputs the target value and the state signal prediction value to the second control signal generator 104.

The second control signal generator 104 receives the target value and the state signal prediction value from the state signal prediction unit 102. The second control signal generator 104 generates the control signal of the DL relay terminal based on the target value and the state signal prediction value, and outputs the control signal to the processor 42.

The processor 42 transmits the output of the control signal generator 46 or the output of the second control signal generator 104 to the wireless device 40.

FIG. 11 illustrates an example of an operation of the state signal prediction unit 102 according to the second embodiment. A state signal (e.g., rotation speed of the motor 66) transmitted from the terminal 28 and received by the controller 10 at timing t is represented by f(t). Timings t1 and t2 represent timings at which the controller 10 receives the state signals transmitted from the terminal 28 operating as the general terminal. Suppose that the attribute of the terminal 28 operating as the general terminal is changed to the DL relay terminal after timing t2. Timings t3, t5, and t7 represent timings at which the controller 10 receives the state signals transmitted from the terminal 28 operating as the DL relay terminal. Compared to the general terminal, the DL relay terminal transmits the state signal at an earlier timing; therefore, AoI of the state signal becomes longer accordingly.

The state signal prediction unit 102 predicts the state signal to be transmitted from the terminal in the case where the terminal operates as the general terminal rather than the DL relay terminal based on the state signal transmitted from the terminal operating as the DL relay terminal and the reception timing of that state signal. The state signal prediction unit 102 determines a value of the state signal as the state signal prediction value. When a control cycle is represented by T, t4 in FIG. 11 is t4=t2+T. The state signal prediction unit 102 calculates a prediction value f(t4) of the state signal to be received at timing t4 using the following equation. A symbol f(t2) is the state signal stored in the memory 50 for the past one time.

f(t4)=(t4−t2)×(f(t3)−f(t2))/(t3−t2)+f(t2) Equation 1

Similarly, a prediction value of the state signal received at timing t5 is obtained by the following equation.

f(t6)=(t6−t3)×(f(t5)−f(t3))/(t5−t3)+f(t3) Equation 2

Note that t6=t4+T.

The state signal prediction unit 102 calculates the state signal prediction values for the state signals from the DL relay terminal received at subsequent timings in the same manner.

This equation is only an example, and other equations may be used to obtain the state signal prediction values.

The above explanation relates to an example where the terminal attribute is switched from the general terminal to the DL relay terminal; however, the same applies in a case where the terminal attribute is switched from the relayed terminal to the DL relay terminal or in a case where the terminal attribute is switched from the UL relay terminal to the DL relay terminal.

The input of the control signal generator 46 is the state signal. The input of the second control signal generator 104 is the state signal prediction value. The second control signal generator 104 differs from the control signal generator 46 in that the input signal is changed from the state signal to the state signal prediction value. The second control signal generator 104 may be similar to the control signal generator 46 in other respects. The second control signal generator 104 generates the control signal of the DL relay terminal based on the state signal prediction value. The control signal generator 46 generates the control signals of the relayed terminal and the UL relay terminal based on the state signal. The second control signal generator 104 may generate the control signal based on the state signal and the state signal prediction value. For example, the second control signal generator 104 may generate the control signal based on an average value of the state signal and the state signal prediction value.

According to the controller 10 of the second embodiment, in the case where the AoI of the state signal transmitted from the DL relay terminal is long, the controller 10 can predict the state signal with a short AoI, thereby shortening the response time of the wireless control system while suppressing deterioration of control quality.

### Third Embodiment

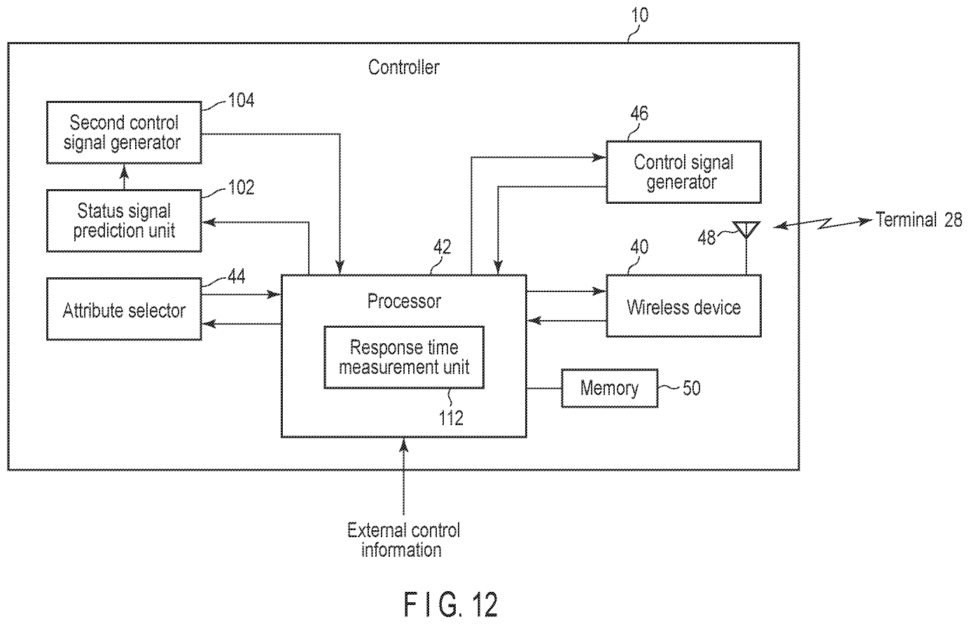

FIG. 12 is a block diagram illustrating an example of the controller 10 according to the third embodiment. Parts corresponding to those of the second embodiment are given the same reference numerals, and detailed explanations are omitted.

The processor 42 further includes a response time measurement unit 112. The response time measurement unit 112 measures a response time of each terminal based on the difference between a timing at which the processor 42 outputs the control signal of each terminal to the wireless device 40 and a timing at which a state signal of each terminal is input to the processor 42 from the wireless device 40.

The processor 42 outputs the response time of each terminal to the attribute selector 44. Based on information output from the processor 42, the attribute selector 44 determines an attribute of a terminal whose wireless line with the controller 10 is most likely to be disconnected as the relayed terminal. The attribute selector 44 determines an attribute of a terminal with the shortest response time among all terminals 28 excluding the terminal whose attribute is the relayed terminal as the DL relay terminal.

In a case where the processor 62 of the terminal 28 is implemented by a CPU, there may be terminals whose response times are regularly short and terminals whose response times are regularly long due to interrupt cycles and other factors. In addition, in a case where the performances of the CPUs of the terminals differ, there may be terminals whose response times are regularly short and terminals whose response times are regularly long. Also, due to communication characteristics, there may be terminals whose response times are short for a certain period of time and terminals whose response times are long for a certain period of time. By operating a terminal whose response time is short as the DL relay terminal, the control signal can be transmitted to the relayed terminal at an early stage, thereby shortening the response time of the wireless control system.

Note that the attribute selector 44 may selects at least one terminal with a short response time as the terminal to operate as the DL relay terminal. Alternatively, the attribute selector 44 may select one or more terminals with short response times as the terminals to operate as the UL relay terminals.

According to the controller 10 of the third embodiment, the relay time can be shortened and the response time between relayed terminals can be shortened.

### Fourth Embodiment

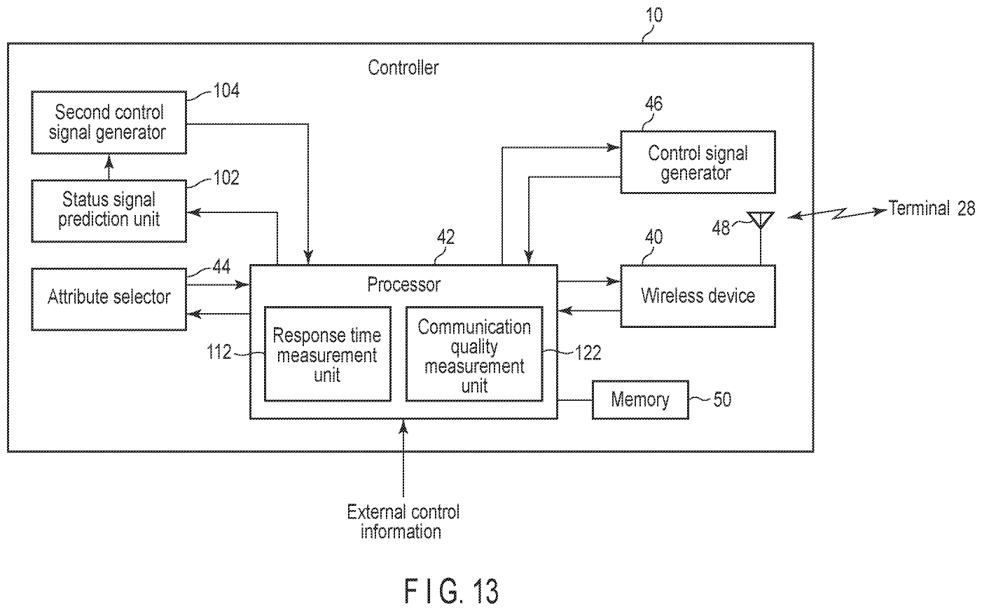

FIG. 13 is a block diagram illustrating an example of the controller 10 according to the fourth embodiment. Parts corresponding to those of the third embodiment are given the same reference numerals, and detailed explanations are omitted.

The processor 42 further includes a communication quality measurement unit 122. The communication quality measurement unit 122 calculates communication quality from a wireless characteristic of each terminal to obtain a communication quality measurement value. The wireless characteristic is, for example, a received power of a wireless frame. The communication quality may be an average received power of wireless frames received n times (n is a natural number) in the past. In this case, the higher the communication quality measurement value, the better the communication quality. Another example of the wireless characteristic is information whether or not the received wireless frame is a retransmitted frame. In this case, the communication quality may be the retransmission ratio of the wireless frames received n times in the past. In this case, the lower the communication quality measurement value, the better the communication quality.

The processor 42 outputs the communication quality measurement value to the attribute selector 44. Based on information output from the processor 42, the attribute selector 44 determines an attribute of a terminal whose wireless line with the controller 10 is most likely to be disconnected as the relayed terminal. The attribute selector 44 determines an attribute of a terminal with the best communication quality among all terminals 28 excluding the terminal whose attribute is the relayed terminal as the UL relay terminal. The attribute selector 44 determines an attribute of a terminal with the shortest response time among all terminals 28 excluding the terminal whose attribute is the relayed terminal or the UL relay terminal as the DL relay terminal.

By operating the terminal with high communication quality as the UL relay terminal, the possibility of delays caused by retransmission of state signals can be reduced and the possibility of relaying state signals within a control cycle can be increased. Note that a plurality of terminals with high communication quality may be assigned to a plurality of UL relay terminals, and one or more terminals with high communication quality may be assigned to DL relay terminals.

The communication quality measurement unit 122 may be installed in the wireless device 40 instead of in the processor 42. Functions of the communication quality measurement unit 122 may be divided, in a manner that each function of the communication quality measurement unit 122 is installed in the wireless device 40 and the processor 42 separately.

The controller 10 according to the fourth embodiment can shorten the relay time and the response time between the controller 10 and the relayed terminal.

### Fifth Embodiment

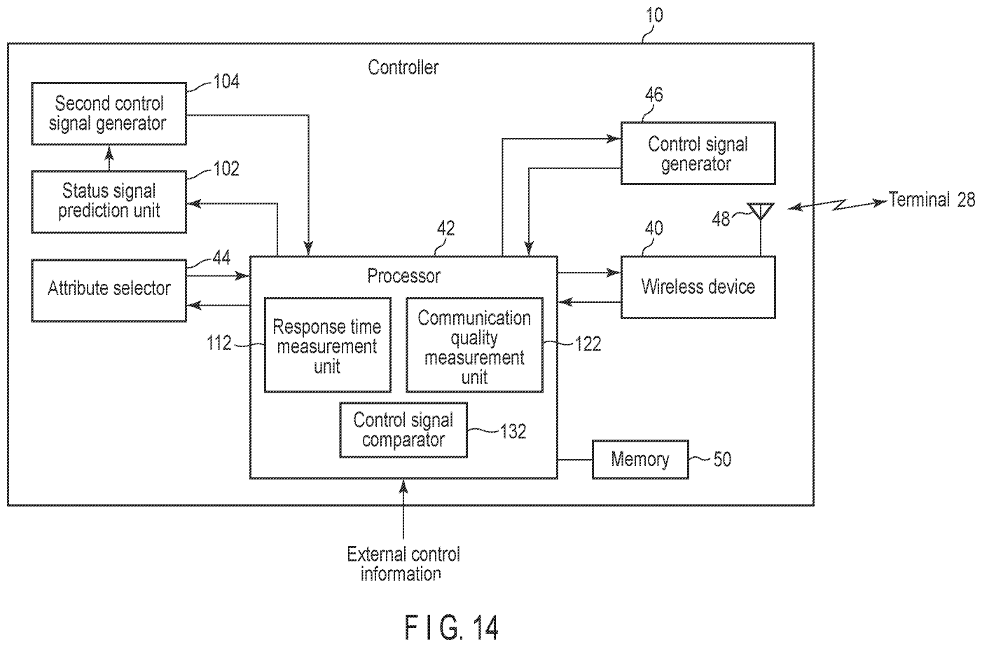

FIG. 14 is a block diagram illustrating an example of the controller 10 according to the fifth embodiment. Parts corresponding to those of the fourth embodiment are given the same reference numerals, and detailed explanations are omitted.

The processor 42 further includes a control signal comparator 132. The control signal comparator 132 outputs to the attribute selector 44 an absolute value of the speed of a motor 66 or an absolute value of the acceleration of the motor 66 of each terminal represented by the control signal of each terminal output from the control signal generator 46 or the second control signal generator 104. The acceleration of each terminal can be obtained from a difference between the speed instructed by the control signal of each terminal received in the past and the speed instructed by the control signal of each terminal received most recently, and a difference between the timing of reception of the control signal in the past and the timing of reception of the control signal most recently.

Based on information output from the processor 42, the attribute selector 44 determines an attribute of a terminal most likely to be disconnected from a wireless line with the controller 10 as the relayed terminal. The attribute selector 44 determines an attribute of a terminal with the largest absolute value of speed or acceleration among all terminals excluding the terminal whose attribute is the relayed terminal as the UL relay terminal. The attribute selector 44 determines an attribute of a terminal with the shortest response time among all terminals excluding the terminal whose attribute is the relayed terminal or the UL relay terminal as the DL relay terminal.

Alternatively, the attribute selector 44 determines an attribute of the terminal with the largest absolute value of speed or acceleration as the relayed terminal. The attribute selector 44 determines an attribute of a terminal with the best communication quality among all terminals excluding the terminal whose attribute is the relayed terminal as the UL relay terminal. The attribute selector 44 determines an attribute of a terminal with the shortest response time among all terminals excluding the terminal whose attribute is the relayed terminal or the UL relay terminal as the DL relay terminal.

Normally, the attribute selector 44 determines an attribute of the terminal with the worst communication quality as the relayed terminal. However, if the communication quality of all terminals is good to some extent, the attribute selector 44 may determine the attribute of the terminal with the largest absolute value of speed or acceleration as the relayed terminal, as in the fifth embodiment. Alternatively, the attribute selector 44 may determine the attribute of the terminal with the largest absolute value of speed or acceleration as the relayed terminal and determine the attribute of the terminal with the largest absolute value of speed or acceleration as the UL relay terminal among all terminals excluding the terminal whose attribute is the relayed terminal.

According to the controller 10 of the fifth embodiment, it is possible to increase the redundancy of control signals for terminals whose AoI (information freshness) is more important. It is possible to receive state signals with short AoI (high information freshness) from terminals whose AoI (information freshness) is more important, and to suppress deterioration of motor control quality.

### Sixth Embodiment

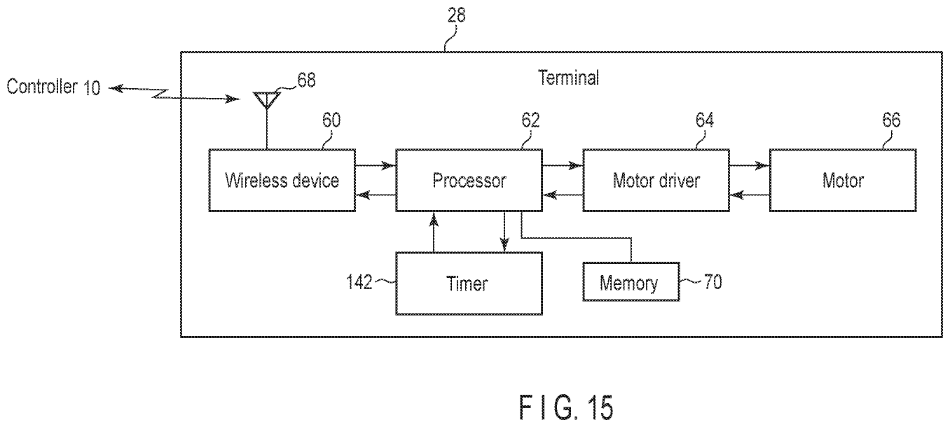

FIG. 15 is a block diagram illustrating an example of the terminal 28 according to the sixth embodiment. Parts corresponding to those of the first embodiment are given the same reference numerals, and detailed explanations are omitted.

The terminal 28 further includes a timer 142. The timer 142 is connected to the processor 62. The processor 62 outputs a start trigger or an end trigger to the timer 142. When a predetermined fixed time has elapsed from a timing at which the timer 142 received the start trigger, the timer 142 outputs an elapsed trigger to the processor 62 at that timing, leaving the elapsed time at 0. However, in a case where the timer 142 receives the end trigger before the predetermined fixed time has elapsed, the elapsed time shall remain 0. The predetermined fixed time is a time shorter than a control cycle. The fixed time is determined by taking into account an actual delay and other factors. For example, if the control cycle is 10 ms and the actual delay is 3 ms, the fixed time is 7 ms, which is the control cycle of 10 ms minus the assumed delay of 3 ms. The actual delay is the sum of a time from when the controller 10 transmits the control signal until the timer 142 receives the start trigger and a time from when the timer 142 generates the elapsed trigger until the controller 10 receives the state signal of this terminal.

The processor 62 receives information on a wireless frame received by the wireless device 60 and performs processing according to the attribute. If the attribute is the UL relay terminal and the destination is its own terminal, the processor 62 outputs the start trigger to the timer 142 and the control signal to the motor driver 64. Thereafter, the processor 62 outputs the state information request signal to the motor driver 64. The motor driver 64 outputs the state signal (including the transmission source) to the processor 62 in response to the state information request signal.

When the processor 62 receives the control signal addressed to a relayed terminal, the processor 62 outputs the end trigger to the timer 142 and outputs the state signal of its own terminal and the state signal of the relayed terminal (including the transmission source) to the wireless device 60. If the elapsed trigger from the timer 142 is input to the processor 62 before the control signal of the relayed terminal is input to the processor 62, the processor 62 outputs the received state signal to the wireless device 60. Alternatively, the processor 62 outputs the state signal output from the motor driver 64 and a past state signal (including the transmission source) of the relayed terminal stored in the memory 70 to the wireless device 60.

According to the terminal 28 whose attribute is the UL relay terminal of the sixth embodiment, even in a case where the terminal 28 does not receive the relay signal of the relayed terminal by the next control cycle, the UL relay terminal 28 can perform feedback control. Deterioration of motor control quality can be suppressed.

### Modified Example

The terminal 28 according to the embodiments described above receives the wireless frame addressed to another terminal and use the information of the wireless frame to generate the relay signal. An operating mode of a general wireless LAN terminal can be switched between a management mode and a monitor mode. Since the wireless LAN terminal operating in the management mode discards the wireless frame addressed to other terminals, the relaying described above cannot be performed. The wireless LAN terminal operating in the monitor mode can receive the wireless frame addressed to other terminals, demodulate them, and transfer the obtained information to a memory for storage without discarding it. However, the wireless LAN terminal operating in the monitor mode cannot perform transmission. Therefore, if the terminal 28 is allowed to include two wireless devices, one of which is operated in the management mode, and the other of which is operated in the monitor mode, a relay terminal can be realized by a general wireless LAN terminal without using a special terminal dedicated for relaying.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless control system comprising:
terminals each including a control target; and
a controller configured to receive a state signal transmitted from each of the terminals, generate a control signal for each of the terminals according to the state signal, and transmit the control signal, wherein
each of the terminals can operate as a relayed terminal or a downlink relay terminal;
the downlink relay terminal is configured to transmit a first state signal representing a state of its own control target and a first control signal for controlling a control target of the relayed terminal; and
the relayed terminal is configured to obtain a second state signal representing a state of its own control target after receiving the first control signal, transmit the second state signal, and control its own control target based on the first control signal.

2. The wireless control system of claim 1, wherein the downlink relay terminal is configured to obtain the first state signal after receiving a second control signal, transmit the first state signal and the first control signal, and control its own control target according to the second control signal.

3. The wireless control system of claim 1, wherein the controller is configured to transmit a control signal for each of the terminals in a fixed cycle, obtain a prediction value of the first state signal at a timing of the fixed cycle based on the first state signal transmitted from the downlink relay terminal, and obtain a control signal for the downlink relay terminal based on the prediction value.

4. The wireless control system of claim 1, wherein
each of the terminals can also operate as an uplink relay terminal; and
the uplink relay terminal is configured to receive a third control signal and the second state signal, control its own control target according to the third control signal, obtain a third state signal representing a state of its own control target, and transmit the second state signal and the third state signal.

5. The wireless control system of claim 4, wherein the controller is configured to measure a response time of each of the terminals and operate a terminal with a short response time as the downlink relay terminal or the uplink relay terminal.

6. The wireless control system of claim 4, wherein the controller is configured to measure a communication quality of each of the terminals and operate a terminal with high communication quality as the uplink relay terminal.

7. The wireless control system of claim 4, wherein
the control target includes a motor; and
the controller is configured to cause a terminal related to a control signal that rotates a motor shaft at a highest speed or a control signal that rotates the motor shaft at a largest acceleration to operate as the uplink relay terminal or the relayed terminal.

8. The wireless control system of claim 4, wherein
the controller is configured to transmit a wireless frame including a header, a destination, an attribute, and a control signal;
the attribute includes information representing the relayed terminal, the downlink relay terminal, the uplink relay terminal, or a general terminal;
the general terminal does not participate in relaying; and
each of the terminals operates as the relayed terminal, the downlink relay terminal, the uplink relay terminal, or the general terminal according to the attribute.

9. The wireless control system of claim 1, wherein
each of the terminals can also operate as an uplink relay terminal; and
the uplink relay terminal is configured to receive a third control signal, measure an elapsed time after receiving the third control signal, control its own control target according to the third control signal, obtain a third state signal representing a state of its own control target; and, in a case where the uplink relay terminal receives the second state signal before the elapsed time exceeds a fixed time, transmit the third state signal and the second state signal; and, in a case where the uplink relay terminal does not receive the second state signal before the elapsed time exceeds the fixed time, transmit the third state signal without transmitting the second state signal.

10. A controller connectable to terminals each includes a control target, the controller is configured to:
receive a state signal transmitted from each of the terminals;
generate a control signal for each of the terminals according to the state signal;
transmit the control signal;
transmit a first instruction to operate each of the terminals as a downlink relay terminal or a second instruction to operate each of the terminals as a relayed terminal, wherein
the first instruction is configured to cause a terminal to transmit a first state signal representing a state of its own control target and a first control signal for controlling a control target of the relayed terminal; and
the second instruction is configured to cause a terminal to obtain a second state signal representing the state of its own control target after receiving the first control signal, transmit the second state signal, and control its own control target based on the first control signal.

11. A terminal including a control target, transmitting a state signal representing a state of the control target to a controller, receiving a control signal transmitted from the controller, and controlling the control target according to the control signal, the terminal configured to:
operate as a relayed terminal or a downlink relay terminal according to an attribute transmitted from the controller;
in a case of operating as the downlink relay terminal, transmit a first state signal representing a state of its own control target and a first control signal for controlling a control target of the relayed terminal; and
in a case of operating as the relayed terminal, obtain a second state signal representing a state of its own control target after receiving the first control signal, transmit the second state signal, and control its own control target based on the first control signal.

12. A non-transitory storage medium storing a computer program controlling a terminal including a control target, the program causing the terminal to:
transmit a state signal to a controller, the state signal representing a state of the control target;
receive a control signal transmitted from the controller;
control the control target according to the control signal;
operate the terminal as a relayed terminal or a downlink relay terminal according to an attribute transmitted from the controller;
in a case of operating the terminal as the downlink relay terminal, cause the terminal to transmit a first state signal representing a state of its own control target and a first control signal for controlling a control target of the relayed terminal; and
in a case of operating the terminal as the relayed terminal, causes the terminal to obtain a second state signal representing a state of its own control target after receiving the first control signal, transmit the second state signal, and control its own control target based on the first control signal.
